(19) United States
(12) Patent Application Publication
(10) Pub. No.: US 2018/0224150 A1
(43) Pub. Date: Aug. 9, 2018

(54) SYSTEM FOR MONITORING AN OPEN CONTAINER

(71) Applicant: Walmart Apollo, LLC, Bentonville, AR (US)

(72) Inventors: Steven Lewis, Bentonville, AR (US); Nicholaus Adam Jones, Fayetteville, AR (US); Matthew Dwain Biermann, Fayetteville, AR (US)

(21) Appl. No.: 15/880,486

(22) Filed: Jan. 25, 2018

Related U.S. Application Data
(60) Provisional application No. 62/456,656, filed on Feb. 8, 2017.

(51) Int. Cl. F24F 11/49; G05B 19/048; F25D 29/00; G01K 1/02

(52) U.S. Cl. CPC F24F 11/49; G05B 19/048; F25D 29/003; F25D 29/005; F25D 29/008; G01K 1/022; G01K 2207/04; F25D 2400/361; G05B 2219/2654; F25D 2700/06; F25D 2700/02; F25D 2700/16; G01K 1/024

(57) ABSTRACT

Examples provide a system for monitoring an open container. A set of sensors captures sensor data associated with one or more items within an open container, such as, but not limited to, a food warmer or a refrigerated/freezer display case. The set of sensors may include one or more infrared (IR) cameras. The set of sensors transmits the sensor data to a monitoring component. The monitoring component processes the sensor data to identify factor(s) associated with one or more items, such as temperature, location of the item, state changes, and freshness of the one or more items. If a factor for a given item exceeds a predetermined threshold value for that factor, the monitoring system outputs an alert notification to a user interface.

### BACKGROUND

In the food industry, it is frequently important to control the temperature of perishable goods throughout production, transportation, storage, and/or sales. For example, foods prepared and/or stored at suboptimal temperatures may become unsuitable for human consumption. Currently, human operators monitor food preparation and storage manually or using contact sensors, such as thermometers. However, these contact sensors may not indicate changes or fluctuations in environmental conditions associated with food stored in an open container. A failure to accurately and efficiently monitor these conditions may result in spoiled food. Moreover, manually monitoring food items is frequently inefficient, potentially error prone, and time consuming.

### SUMMARY

Examples of the disclosure provide a monitoring system for an open container. The monitoring system includes a monitoring component implemented on at least one processor; an image capturing device configured to capture images of an interior portion of the open container; and a communication component communicatively coupled to the image capturing device and configured to transmit the captured images of the interior portion of the open container to the monitoring component.

Other examples of the disclose provide a method for monitoring an open container. Captured image data of an interior environment of an open container is obtained from an image capture device associated with the open container. The captured image data is processed to identify one or more factors associated with one or more items contained within the open container. An alert is generated if at least one identified factor exceeds a threshold.

Still other examples provide one or more computer storage devices storing computer-executable instructions for monitoring an open container environment. The computer-executable instructions are executed by a computer to cause the computer to perform operations, including obtaining captured image data of an interior environment of an open container from an image capture device associated with the open container; processing the obtained captured image data to identify one or more factors associated with one or more items contained within the open container; and generating an alert responsive to at least one of the one or more identified factors exceeding a threshold.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing system for monitoring an open container.

FIG. 2 is an exemplary block diagram illustrating a monitoring system for an open container.

FIG. 3 is an exemplary block diagram illustrating sensor data processing for open container monitoring.

FIG. 4 is an exemplary block diagram illustrating a set of sensors.

FIG. 5 is an exemplary block diagram illustrating an open container.

FIG. 6 is an exemplary block diagram illustrating a set of databases for analyzing processed sensor data.

FIG. 7 is an exemplary flowchart illustrating operation of a monitoring system monitoring an open container.

FIG. 8 is an exemplary flowchart illustrating operation of a computing device for generating processed sensor data.

FIG. 9 is an exemplary flowchart illustrating operation of a computing device for monitoring one or more items in an open container by an IR container.

Corresponding reference characters indicate corresponding parts throughout the drawings.

### DETAILED DESCRIPTION

Referring to the figures, examples of the disclosure enable monitoring one or more items in an open container. In some examples, a monitoring component is provided for automatic monitoring of one or more food items in the open container using sensor data received from a set of sensors associated with the open container. The monitoring component automates monitoring a state of the one or more items to identify factors that may impact the safety, production, and/or quality of the items. The monitoring component further minimizes human error while minimizing costs associated with the monitoring.

In other examples, the set of sensors include a set of one or more cameras or other image capture devices. The set of cameras provide real-time imaging of the one or more item(s) and/or data recording. The set of sensors sends images and data to the monitoring component, which may be implemented on a remote computer, via Ethernet or another network connection.

Other examples provide at least one infrared (IR) camera associated with an interior of the open container and/or at least one IR camera associated with an exterior of the open container. The IR camera(s) enable infrared thermography to generate accurate, automated non-contact temperature measurements of item(s) within the open container over time. This enables more non-contact monitoring of one or more items within an open container system over time for improved quality assurance of perishable items more efficiently than thermocouples or other contact temperature sensors.

In still other examples, the system utilizes one or more IR cameras to monitor items selected by a user and locations of selected items within the open container to determine an optimal food placement within the open container based on temperature differentials via the thermal imaging. The system generates instructions for item placement to a user. These examples provide improved presentation of items, avoids incomplete cooking of items, prevents improper refrigeration of items, and improves user efficiency in managing perishable items.

Moreover, the monitoring system in some examples connects to one or more remote computing devices via a network connection. This enables seamless integration with other inspection and process control systems for improved scalability over manual systems.

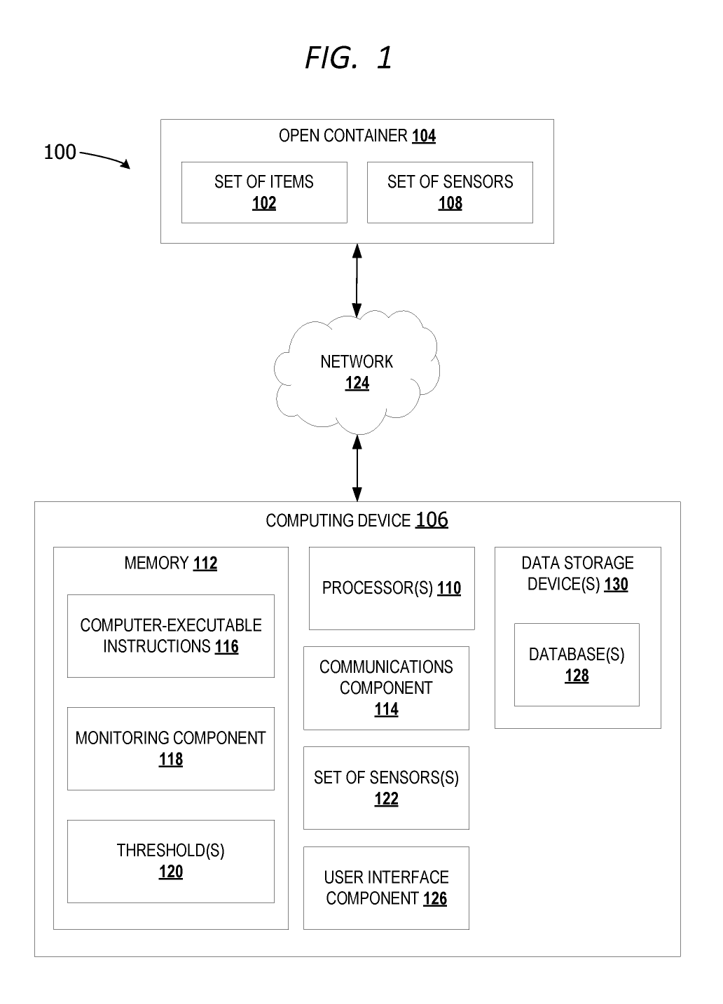

Referring again to FIG. 1, an exemplary block diagram illustrates a system 100 for monitoring a set of one or more items 102 in an open container 104. In the example of FIG. 1, the computing device 106 communicating with a set of sensors 108 for gathering sensor data associated with the set of items 102 represents a system for monitoring the open container 104.

In some examples, the open container 104 is a container having at least a portion of a side of the container open and/or at least one open side of the container. In other examples, the open container 104 is an enclosed container having an open door or other point of access enabling a user to add items or remove items from the container.

For example, an open container may be implemented as a food warmer, a refrigerated display case, a frozen foods display case, an oven/heated unit, a rotisserie cooking unit, a bread toasting unit, a food conveyor belt, or any other suitable type of open container. The set of items 102 in some examples are edible items. For example, but without limitation, the set of items 102 may include bread, meat products, dairy products, or any other types of edible items.

The computing device 106 represents any device executing instructions (e.g., as application programs, operating system functionality, or both) to implement the operations and functionality associated with the computing device 106. The computing device 106 may include a mobile computing device or any other portable device. In some examples, the mobile computing device includes a mobile telephone, laptop, tablet, computing pad, netbook, gaming device, and/or portable media player.

The computing device 106 may also include less portable devices such as desktop personal computers, servers, kiosks, tabletop devices, industrial control devices, wireless charging stations, and electric automobile charging stations. Additionally, the computing device 106 may represent a group of processing units or other computing devices.

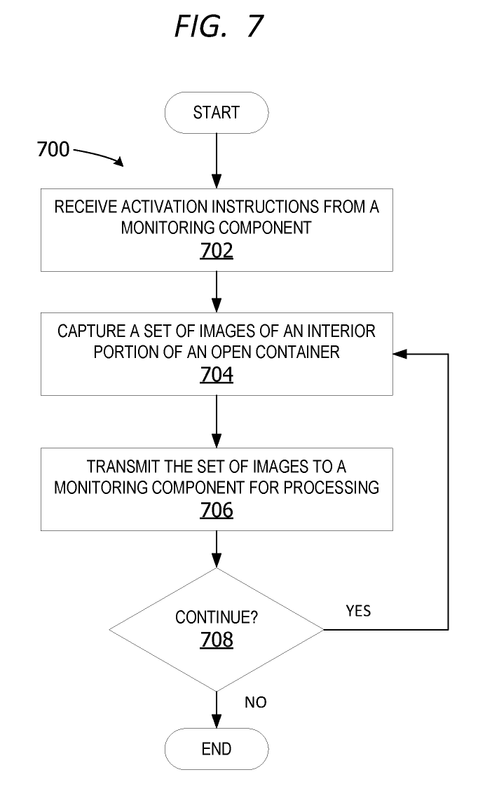

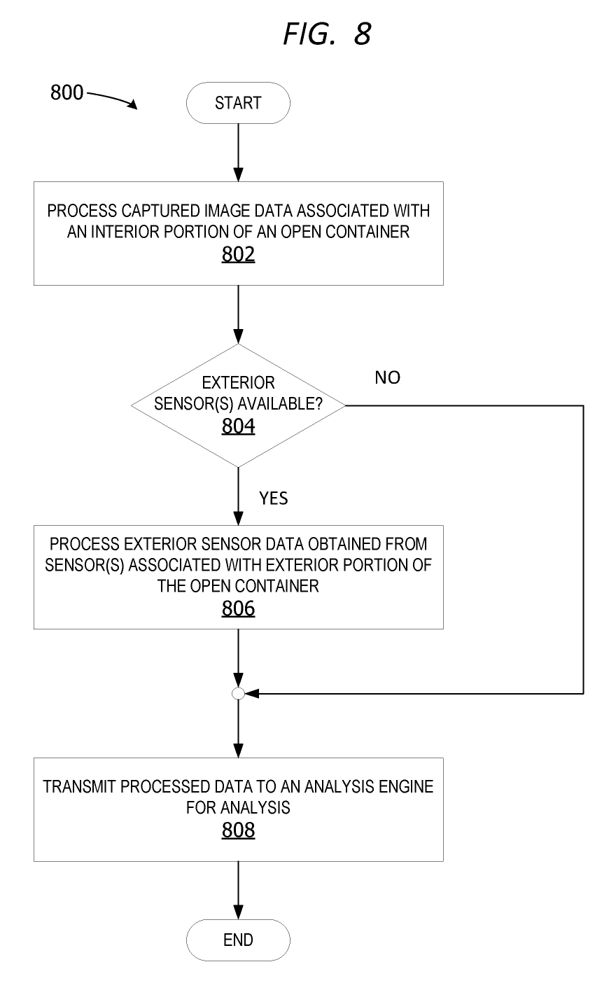

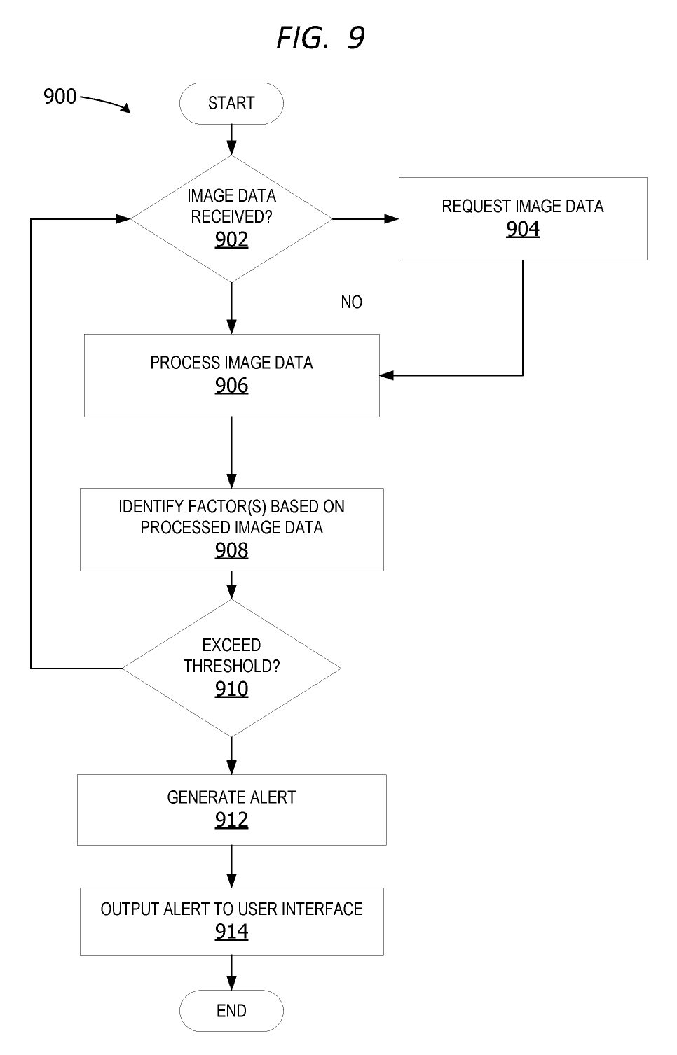

In some examples, the computing device 106 includes one or more processor(s) 110, a memory 112, and a communications component 114. The one or more processor(s) include any quantity of processing units. At least one processor of the one or more processors(s) 110 is programmed to execute computer-executable instructions 116 for implementing the examples herein. The computer-executable instructions 116 may be performed by the processor or by multiple processors within the computing device 106, or performed by a processor external to the computing device 106. In some examples, the processor is programmed to execute instructions such as those illustrated in the figures (e.g., FIG. 7, FIG. 8, and FIG. 9).

In some examples, the one or more processor(s) represent an implementation of analog techniques to perform the operations described herein. For example, the operations may be performed by an analog computing device and/or a digital computing device.

The computing device 106 further has one or more computer readable media such as the memory 112. The memory 112 includes any quantity of media associated with or accessible by the computing device 106. The memory 112 may be internal to the computing device (as shown in FIG. 1), external to the computing device (not shown), or both (not shown). In some examples, the memory 112 includes read-only memory and/or memory wired into an analog computing device.

The memory 112 stores data, such as one or more applications. The applications, when executed by the processor, operate to perform functionality on the computing device. The applications may communicate with counterpart applications or services such as web services accessible via a network. For example, the applications may represent downloaded client-side applications that correspond to server-side services executing in a cloud.

The memory 112 further stores one or more computer-executable components. Exemplary components include a monitoring component. In other examples, the memory 112 includes an analysis engine, a machine learning component, sensor data, image capture data, and/or processed sensor data.

In some examples, the monitoring component 118, when executed by the processor of the computing device 106, causes the processor to obtain captured image data of an interior environment of an open container from an image capture device associated with the open container; process the obtained captured image data to identify one or more factors associated with one or more items contained within the open container; and generate an alert responsive to at least one of the one or more identified factors exceeding a threshold.

The set of sensors 108 is a set of one or more sensors associated with an interior of the open container 104. The set of sensors may include one or more image capture devices, one or more thermometers, one or more hygrometers, one or more barometers, one or more motion sensors, or any other type of sensor. An image capture device may include an analog camera, a digital camera, an IR camera, or other type of camera. In some examples, an IR camera is located inside the open container or associated with an interior portion of the open container such that the IR camera captures images of at least a portion of the interior of the open container 104.

In other examples, the set of sensors includes one or more sensors associated with an exterior portion of the open container 104, such as the set of sensors 122. The set of sensors 122 may include one or more sensors integrated within the computing device 106 in some examples. In other examples, the set of sensors 122 includes one or more sensors exterior to both the computing device 106 and the open container 104.

The monitoring component 118 receives sensor data from the set of sensors 108 via a network 124 using communications component 114. Network 124 may include, without limitation, a local area network (LAN), such as an Ethernet connection, or a wide area network (WAN), such as the Internet. The network 124 may be a wired network or a wireless network, such as WI-FI.

In other examples, the monitoring component 118 requests the sensor data from the set of sensors 108 via the network 124. The set of sensors 108 transmits the sensor data via the network in response to the request. In other examples, the set of sensors 108 automatically transmits the sensor data to the monitoring component 118 in real time as the sensor data is generated. In still other examples, the sensor data is sent at regular intervals or in response to a predetermined event.

Communications component 114 may include a network interface card and/or computer-executable instructions (e.g., a driver) for operating the network interface card. Communication between the computing device and other devices may occur using any protocol or mechanism over any wired or wireless connection. In some examples, the communications interface is operable with short range communication technologies such as by using near-field communication (NFC) tags.

In some examples, an alert is generated and output to one or more users via a user interface component 126. The alert may be generated if the sensor data indicates one or more factors associated with at least one item exceeds a threshold. For example, a factor for an item may be a temperature of a food item. The threshold may be a temperature range. In some examples, if the sensor data indicates the temperature of the at least one food item exceeds the threshold (higher or lower than the threshold temperature range), an alert is generated and output via the user interface component 126.

The user interface component 126 may include a graphics card for displaying data and alerts to one or more users, as well as receiving data from one or more users. The user interface component 126 may also include computer-executable instructions (e.g., a driver) for operating the graphics card. Further, the user interface component 126 may include a display (e.g., a touch screen display or natural user interface) and/or computer-executable instructions (e.g., a driver) for operating the display. The user interface component 126 may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular manner.

The one or more threshold(s) 120 in this example is stored within the memory 112. In other examples, the threshold(s) 120 may be stored within one or more database(s) 128 within one or more data storage devices(s) 130. The data storage device(s) may include rotational storage, such as a disk. The data storage device(s) may also include non-rotational storage media, such as a solid-state drive (SSD) or flash memory. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device.

The threshold(s) 120 include a threshold for a given factor or state change. In some examples, the threshold(s) 120 include a threshold duration of time within the open container for food removal. When a duration of time factor for a given item exceeds the threshold duration, an alert is generated to notify a user to remove the given item.

In another example, the threshold(s) 120 include a temperature range threshold. If a temperature of a given item within the open container is greater than or less than the threshold temperature range, the monitoring component 118 generates an alert notifying the user to modify a temperature within the open container or remove the item which has fallen outside the acceptable temperature range and/or replace the expired item with one or more fresh items.

In other examples, a temperature inside an open container falling outside an acceptable range may indicate a failure of a heating element or a cooling element within the open container. In these examples, the alert is generated to notify a user of malfunction.

In still other examples, the monitoring component 118 generates a timestamp indicating a time when an item is added to the open container 104, a time when an item is removed from the open container, or a time when a change in state occurs, relative to one or both of an item within the open container or an environment associated with the open container. In still other examples, the monitoring component includes a timer. An alert is generated by the monitoring component when the timer indicates an item should be replaced or removed from the open container 104.

For example, a timer may track a duration of time following a change in state, such as a factor exceeding a threshold. If a predetermined period of time occurs following the change in state, the monitoring component alerts staff to replace one or more staled items in response to one or more factures exceeding one or more threshold values. For example, if a temperature of a given item falls below a threshold temperature and remains below the threshold temperature for a predetermined period of time, the monitoring component alerts a user to replace the given item. This avoids incomplete cooking or improper refrigeration of perishable items.

In yet other examples, the monitoring system analyzes camera image data and/or other sensor data to monitor heat radiating from the lip or seam of a heat-sealed cellophane cover on a given item within the open container. The temperature along the perimeter of the item packaging is checked using the IR image data and/or non-IR image data to determine if the packaging of a given item within the open container is properly sealed and/or enclosed within packaging. If the packaging is perforated or otherwise opened, an alert is generated notifying a user to remove or replace the damaged or improperly packaged item.

In still other examples, the monitoring system analyzes IR image data and/or other sensor data to determine an amount of liquid in a drink container. If the drink container is over-filled or under-filled, an alert is generated to a user to remove or replace the improperly filled drink container.

The monitoring component 118 associated with a set of sensors may be utilized to monitor the environment associated with a food warmer, cooking equipment associated with the open container, package sealing of items within the open container, filling lines, warming operations, cooling operations, and/or drying operations.

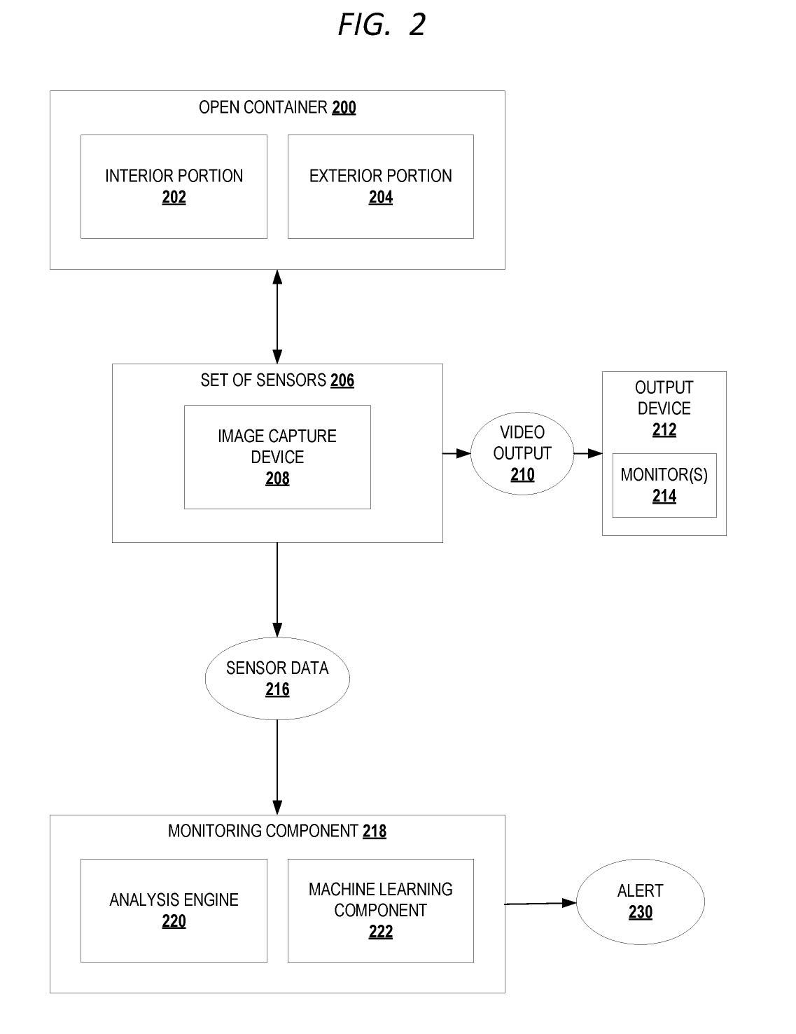

FIG. 2 is an exemplary block diagram illustrating a monitoring system for an open container. The open container 200 includes an interior portion 202 and an exterior portion 204. The interior portion 202 is partially enclosed and includes at least one item within the interior portion. The set of sensors 206 monitors the one or more items in the interior portion 202 of the open container 200. In other examples, the set of sensors 206 also monitors at least a portion of the exterior portion 204 of the open container 200.

The set of sensors 206 includes one or more sensors for monitoring the item(s) within the open container 200 and/or the environment within and/or around the open container 200. In this example, the set of sensors 206 incudes at least one image capture device 208. The image capture device 208 may be implemented as any type of device for capturing images. The image capture device 208 may generate still images or a series of images in a video. The image capture device 208 in this example may be implemented as an IR camera using thermographic sensors to generate images and/or a non-IR camera using light sensors to generate images.

In some examples, the image capture device 208 is permanently mounted. In other examples, the image capture device 208 is moveably mounted such that the image capture device may be moved or relocated to a non-permanent position. The image capture device 208 may include a color scale or gray scale. The image capture device 208 may optionally be set up with the color scale or gray scale to optimize the images generated by the image capture device 208.

The set of sensors 206 in some examples transmits video output 210 to an output device 212, such as, but without limitation, one or more monitor(s) 214. In this non-limiting example, the video output 210 is analog video output capable of being viewed on video monitor(s) 214.

In other examples, the set of sensors 206 sends sensor data 216 to a monitoring component 218. Monitoring component 218 may be implemented local to open container 200 or remote from open container 200, in these examples. In some examples, the sensor data may include IR camera still images, IR camera video images, digital video output, or other image data. For example, the sensor data 216 may include Moving Pictures Experts Group (MPEG) video output. In still other examples, the sensor data 216 may include temperature data, timestamp data, barometer data, hygrometer data, change of state data, non-IR digital video data, analog video data, still images, or other data generated by one or more sensors.

Monitoring component 218 includes an analysis engine 220 and/or a machine learning component 222 for analyzing the sensor data 216. The analysis engine 220, in some non-limiting examples, includes trend analysis algorithms for generating an earliest possible warning regarding changing temperature or other changing state of one or more items within the open container. In other examples, the analysis engine 220 analyzes the processed sensor data to identify items within the open container, locate items within the open container, track location changes of items within the open container, track duration of time an item remains within the open container, and/or determine temperature of items in the open container based on image data, temperature readings, and/or other sensor data collected by the set of sensors.

The machine learning component 222 may include pattern recognition, modeling, or other machine learning algorithms to analyze sensor data and/or database information to generate alerts, including notifications and/or instructions, temperature trends, item location trends, and/or other patterns in temperature/item location associated with a particular open container.

In some examples, the analysis engine and/or machine learning component 222 compares one or more IR images in the sensor data and/or one or more temperatures for the item to a predetermined pattern stored in a database to identify an item, item location, item temperature, item packaging integrity, item freshness, moisture level, or other factors associated with the item.

In some examples, the machine learning component 222 uses the data stored in one or more databases with real-time image capture data to learn how to optimize food placement within the open container, and optimization of temperature settings of the open container for maximum item freshness, to prevent spoilage, keep the open container filled, efficiently replace stale items, and/or improve item presentation/availability to users.

The monitoring component 218 may analyze the sensor data to detect state changes in the open container 200 and/or detect state changes in one or more items located within the open container 200. This enables detection of abnormal process variations before a food item is impacted by changes in the temperature or other state changes.

For example, the monitoring component 218 may automatically detect state changes including food spoilage, food color changes, water/moisture level of food items, dryness of food items, humidity within the container, food freshness level, item package integrity, temperature of an item, temperature within the container, changes in temperature of an item over time, and/or changes in temperature within the interior portion 202 of the container over time. In some examples, moisture content may indicate a degree of spoilage or whether a food item is fully cooked. The monitoring system in this example ensures the food item is sufficiently cooked without being over-cooked or dried out. In other examples, the monitoring system may detect a different temperature foreign object entering the monitored area of the interior portion of the open container, such as a room temperature item dropping into the open container where hot items are maintained at a specific temperature or temperature range. In such an example, an alert may indicate that an item having a different temperature has entered the interior portion in order to notify of potential misplaced objects or an item that has been replaced at the incorrect temperature and is to be removed from the open container.

In other examples, the monitoring component 218 analyzes the sensor data 216 to detect environment changes outside the open container 200, as well as changes within the open container 200. The analysis engine 220 and/or machine learning component 222 interpolates the effects of changes to the exterior environment to the food within the open container. For example, temperature changes external to the container over time that may impact a temperature within the open container.

For example, an open container 200 near an entrance or exit location of a building may experience changes to the outside environment of the open container when the door to the building is opened or closed. The opening and closing of the building door may change the temperature of the environment adjacent to the exterior portion of the open container 200, which may in turn impact the temperature of the interior portion of the open container. In other words, opening or closing a door near the open container may introduce warmer or colder air into the environment adjacent to the open container 200. These exterior environmental changes may likewise influence the temperature inside the open container. The open container may have to adjust heating or cooling elements to compensate for the environmental changes exterior to the container in order to maintain desired temperature levels for the food items within the interior portion 202 of the container. In these examples, the sensor data is analyzed as part of a feedback loop to help control oven/heater or refrigerator/freezer temperatures.

The sensor data in other examples is monitored and temperature adjusted to maintain temperature uniformity within the open container. This prevents uneven heating or uneven cooling of items within the open container.

The monitoring component 218 in some examples analyzes the sensor data 216 to determine when a factor exceeds a threshold and/or a state of an item changes. In response to a factor exceeding a threshold and/or a state change, the monitoring component 218 generates an alert 230 for one or more users. The alert 230 may be an audible alarm, a light, a flashing light, a verbal warning, a visual or other textual notification displayed by an output device, or other alarm. In this example, the alert 230 includes a timer to notify staff when to replace one or more items in the open container that have exceeded their freshness.

The factor may include any characteristic or state of the item or the open container. For example, a factor or state of an item may include a temperature of an item, change in temperature of an item, a change in location of an item, a current location of an item, a moisture level of an item, or other characteristic of the item.

In some examples, the monitoring component 218 analyzes the sensor data 216 to determine factors such as, when the interior portion 202 of open container 200 reaches capacity (filled with a maximum number of items) and/or when the open container is empty. In other examples, the monitoring component 218 utilizes sensor data 216 to determine a time when an item is placed inside the interior portion 202 of the open container and/or a time when an item is removed from the interior portion 202 of the open container 200. In still other examples, the monitoring component 218 analyzes the sensor data 216 to determine when a door associated with access to the interior portion 202 of the open container is opened or closed.

In still other examples, the monitoring component 218 analyzes sensor data 216 to determine if a door associated with access to the interior portion 202 is left open, a heater component is malfunctioning, a turn table is moving or is not moving, a rotisserie cooker is rotating the item, a light is turned on, a refrigerator is cooling, a temperature of the interior portion 202 is within an acceptable temperature range, or any other factor.

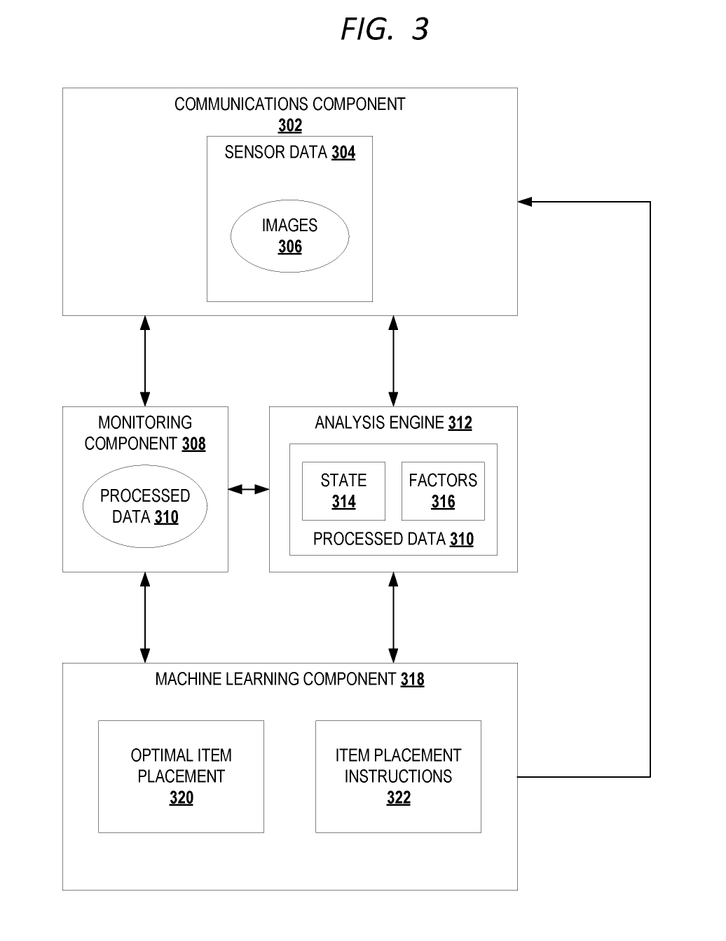

FIG. 3 is an exemplary block diagram illustrating sensor data processing for open container monitoring by a monitoring system, such as monitoring system 100 in FIG. 1. The communications component 302 receives sensor data 304 from a set of sensors, such as set of sensors 206 in FIG. 2. The sensor data 304 may include images 306 from one or more image capture devices associated with an open container. The one or more images may include images of items within an open container, for example. The communications component 302 transmits the sensor data to the monitoring component 308.

The monitoring component processes the sensor data 304 to generate processed data 310. In some examples the monitoring component 308 includes an analysis engine and/or a machine learning component. In other examples, the analysis engine 312 and/or the machine learning component 318 are implemented as separate components from the monitoring component 308. In these examples, the monitoring component 308 transmits the processed data 310 to the analysis engine and/or the machine learning component 318.

The analysis engine 312 analyzes the processed data 310 to identify information about items associated with an open container. The identified information may be a state 314 of the set of items and/or one or more factors 316 associated with at least one item in the set of items associated with a monitored portion of the open container. In still other examples, the analysis engine 312 analyzes the processed data 310 to detect a food freshness level, food spoilage indication, food package integrity, food temperature indication, component malfunction, frequency of movement of one or more items into and out of the open container, frequency of replacement of items, heating element operation, refrigeration/freezer element operation, and/or access point state. An access point state in some examples is a state of a door or other access point to an interior portion of an open container. An access point state may be an open state or a closed state, for example.

The state 314 in some examples is a state of at least one item. The state may indicate a current temperature of an item, a duration of time the item has been within the open container, whether cooking is complete, whether an expiration has expired, whether an item packaging is intact, a moisture level of the item, etc.

In other examples, the state 314 is a state of the open container. The state may indicate whether one or more components of the open container is functioning, malfunctioning, turned on, turned off, or otherwise operating within expected parameters.

The machine learning component 318 analyzes the processed data 310, the state 314, and/or the one or more factors 316 to identify an optimal item placement 320 and/or to generate item placement instructions 322. The generated item placement instructions 322 are output to one or more user interfaces to direct item placement change of one or more items within the open container. The item placement instructions 322 optimize food placement within the open container 200 using the learned optimal item placement 320 of machine learning component 318 based on processed data 310 of monitoring component 308.

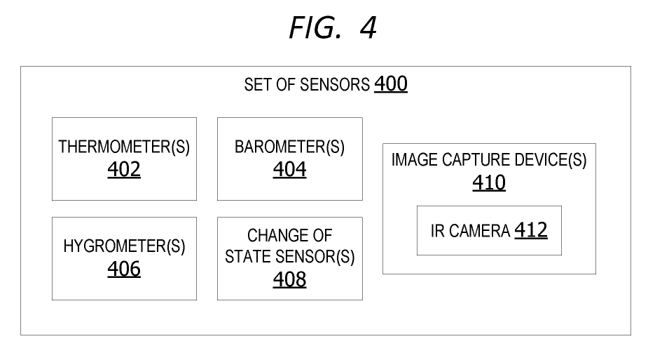

FIG. 4 is an exemplary block diagram illustrating a set of sensors. The set of sensors 400 is a set of one or more sensors. The set of sensors 400 in some examples includes one or more thermometer(s) 402, one or more barometer(s) 404, one or more hygrometer(s) 406, one or more change of state sensor(s) 408, and/or one or more image capture device(s) 410. In some examples, the image capture device(s) 410 includes at least one IR camera 412.

A change of state sensor is a non-electrical, non-reversing sensor attached to an item within the open container that monitors a change of state of the item, such as a change in temperature, a change in a state of matter, a change in a moisture level or texture, etc. A change of state of matter includes a change from ice to water, a change from water to steam, etc. The change of state sensor in some examples is a sensor in the form of a label, pellet, crayon, or lacquer. In other examples, the change of state sensor is an add-on or attachment to a label, lid, cap, display stand, turn table, steam traps, or another item.

When a change in state occurs, the change of state sensor changes appearance or otherwise deforms to indicate the change. A change of state sensor may be implemented as one or more dots on a label. The dot may change color or disappear when a temperature change occurs.

In other examples, the change of state sensor includes multiple dots. One or more of the dots changes color to indicate a different temperature changes. For example, a first dot changing color may indicate a first temperature, a second dot changing color indicates a different, second temperature. For example, if the item changes temperature from seventy degrees to seventy-five degrees, the first dot changes color and if the temperature changes from seventy degrees to sixty-five degrees, a second dot changes color.

A change of state sensor may be implemented as a label on a perishable food item. When a temperature of the food item changes, a portion of the label becomes hotter or colder which changes color to indicate the temperature change. One or more image capture device(s) 410 may capture images of the change of state sensor(s) 408 and send captured image data as sensor data to a monitoring component for identification of factors associated with items being monitored, for example.

In other examples, the change of state sensor is a liquid crystal display (LCD) associated with the label. The LCD display changes color to indicate the change. For example, a white label may change to a brown, blue, green, or yellow tinted color to indicate the change in temperature. In one example, a white dot on the label may change to a black dot. An image capture device detects the change in state by capturing the change in color of the portion of the label.

In other examples, the change of state sensor is a pellet attached to the item. When the temperature changes the pellet visually deforms or melts to indicate the state change. In some examples, a change of state sensor is nonreversible. When the sensor changes color or otherwise deforms to indicate a temperature change, the deformation is non-reversible. For example, if the sensor shows a change from a first temperature to a second temperature by changing a color of a white dot to a black dot, the black dot does not change back to the white color when the temperature returns to the previous first temperature.

In other examples, a set of sensors on an exterior portion of the open container also includes one or more change of state sensors associated with an exterior portion of the open container. For example, a change of state sensor may be implemented as a label on an exterior surface of the open container.

Sensor data from the thermometer(s) 402, barometer(s) 404, hygrometer(s) 406, and/or change of state sensor(s) 408 may be sent in concert with image capture data generated by image capture device(s) 410 to the monitoring component for analysis. For example, hygrometer data indicating moisture levels within the open container may be sent with IR image data to the monitoring component. The monitoring component analyzes the moisture data and IR data to determine whether a food item is moist and fully cooked to avoid overcooking and/or drying out the food item.

In other examples, the image capture device(s) 410 capture or read one or more other sensors. For example, a non-IR camera may capture an image of a thermometer inside the open container to determine the current temperature inside the open container and/or capture an image of a thermometer outside the open container to determine the current temperature outside the open container.

The sensors may include an active mode, in inactive mode, and a failure mode. In an active mode, sensor data is obtained and/or transmitted to the monitoring system as described herein. In an inactive mode, a sensor may be in an “off state,” or otherwise deactivated from obtaining sensor data. In a failure mode, a sensor may be in an “on state” but unable to obtain sensor data, or may be transitioned to the inactive mode due to a component failure or other failure associated with an element of the sensor. For example, a failure mode of the camera system may include the camera system being in error, unable to detect images, out of sync with a database of the monitoring system, or any other suitable issue. When the monitoring system detects a failure mode for one or more sensors, an alert may be generated to prompt a manual inspection of the open container and/or the monitoring system until the detected failed sensor is restored, replaced, or otherwise repaired.

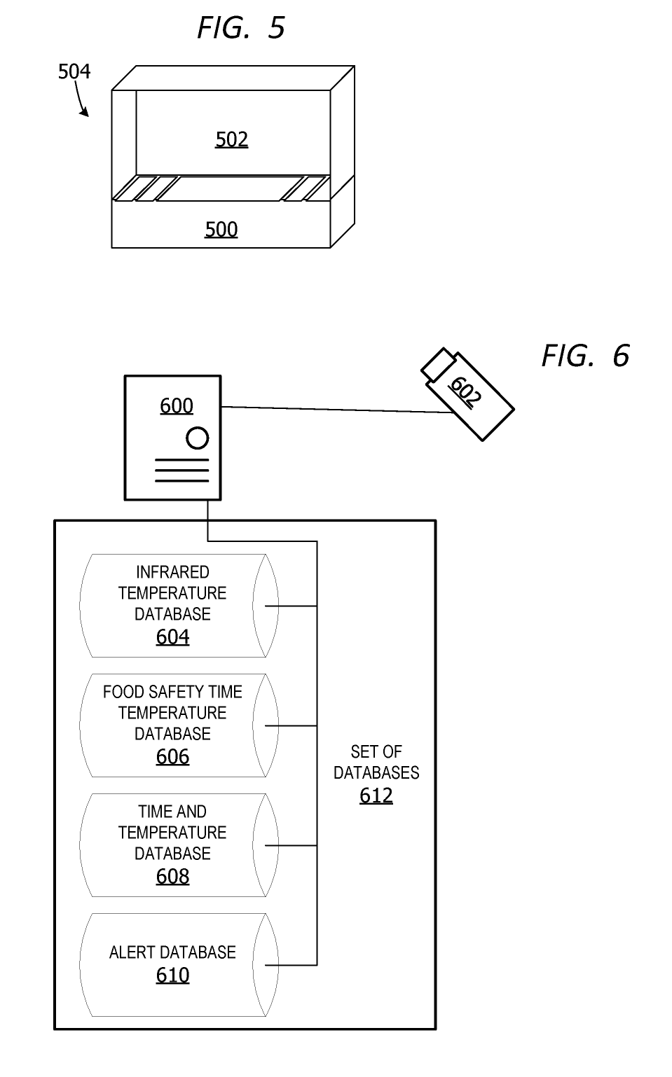

FIG. 5 is an exemplary block diagram illustrating an open container. In this example, the open container 500 is a container in an open warmer system, such as a warm display case. The open container 500 in this non-limiting example includes an interior portion 502 and an exterior portion 504.

FIG. 6 is an exemplary block diagram illustrating a set of databases for analyzing processed sensor data. Computing device 600 may be an illustrative example of one implementation of computing device 106 in FIG. 1. The computing device 600 in this example is communicatively coupled to at least one IR camera 602. In this non-limiting example, the IR camera 602 generates thermographic images which are routed to the computing device 600 via a network connection, such as, but without limitation, an Ethernet connection.

The IR camera may be implemented, in some examples, as a small, portable device which is easy to use and may be positioned almost anywhere within or near the open container to capture IR image data. In still other non-limiting examples, the IR camera is permanently mounted to at least a portion of the open container.

In other examples, the IR camera includes applications and/or firmware enabling automated food monitoring control. These applications and/or firmware provide imaging tools and libraries that are hardware and/or language independent to enable efficient implementation of thermographic monitoring within an interior of an open container including a set of food items.

The IR camera may include a spot-meter operating mode. In the spot-meter operating mode, the IR camera finds the temperature at a particular point or location. The spot-meter mode may be utilized where a location of an item within the open container is known or identifiable.

In other examples, the IR camera includes an area measurement operating mode. The area measurement operating mode isolates a selected area within the open container, an area on a particular item, or an area on another object. The area measurement optionally provides a maximum, minimum, and average temperature inside the selected area. The temperature measurement range is configurable, and may be selectable by a user in some examples. The area measurement operating mode may be utilized where the specific location of a given item is unknown and/or undeterminable. The IR camera 602 in these examples may be programmed to find and measure the minimum and maximum temperatures within a defined area. If the temperature within the defined area falls above or below a threshold range, an alert is generated. The alert may notify a user to check the sensor IR image or other sensor data output, remove or replace one or more items, and/or adjust the temperature within the open container.

The IR camera transmits image data to the computing device 600 via a communication interface in some examples. The monitoring component of the computing device 600 analyzes the image data using information in set of databases 612.

In this non-limiting example, the set of databases 612 includes an IR temperature database 604, a food safety time temperature database 606, a time and temperature database 608, and/or an alert database 610. The IR temperature database 604 is a database storing information in IR signatures corresponding to distinct temperatures. The monitoring component compares IR signatures in the sensor data associated with a given item to the database information IR signatures to determine a non-contact temperature of the given item.

The food safety and temperature database 606 includes predetermined food safety information, including thresholds for temperatures associated with different types of food to maintain freshness, safety, prevent spoilage, detect spoilage, and maintain a safe temperature for various perishable foods.

The time and temperature database 608 includes a log of timestamps and/or a log of temperatures associated with actions and/or events associated with the container. For example, the database may contain a timestamp when a given food item is placed inside the open container, a timestamp when the given food item is removed from the open container, a timestamp associated with each temperature reading for the given item, and the like.

The time and temperature database 608 may also include a log of the temperature of one or more food items and/or the temperature of the interior of the container associated with a given timestamp. The monitoring component may utilize the temperature and associated timestamps to extrapolate how events from the time database correlate with the temperature of items at the various moments in time as indicated by the one or more timestamps.

The alert database 610 in some examples includes a stored log of alerts generated by the monitoring system based on the analysis of the sensor data and information in the set of databases 612.

The set of databases 612 may include one or more databases not included in FIG. 6. For example, the set of databases 612 may include an item placement database. An item placement database may include a log of where items are placed within the open container at one or more points in time as indicated by a set of timestamps. The item placement database may include timestamps for items are removed from specific locations within the open container. The item placement database in some examples may be used to correlate items with locations within the open container. In other words, the analysis engine utilizes information within the item placement database to determine an optimal location to increase likelihood of item selection by a user, a location most likely to keep an item fresh or resist spoilage, and the like. The monitoring component determines an optimal food placement for a given item, generates placement instructions, and outputs the placement instructions to a user interface and/or stores the placement instructions in the item placement database.

FIG. 7 is an exemplary flowchart illustrating operation of a monitoring system monitoring an open container. The process shown in FIG. 7 may be performed by a sensor, such as, but not limited to, a sensor in set of sensors 108 or 122 in FIG. 1, set of sensors 206 or image capture device 208 in FIG. 2, set of sensors 400 in FIG. 4, or infrared camera 602 in FIG. 6. Further, execution of the operations illustrated in FIG. 7 is not limited to a sensor. One or more computer-readable storage media storing computer-readable instructions may execute to cause at least one processor to implement the operations illustrated in FIG. 7.

Activation instructions are received from a monitoring component at operation 702. A set of images of an interior portion of an open container are captured at operation 704. The set of images are transmitted to the monitoring component for processing at operation 706.

A determination is made as to whether to continue at 708. If yes, the process iteratively repeats operations 704 through 708. If no, the process terminates thereafter.

FIG. 8 is an exemplary flowchart illustrating operation of a computing device for generating processed sensor data. The process shown in FIG. 8 may be performed by a monitoring component executing on a computing device, such as, but not limited to, the monitoring component 118 in FIG. 1, the monitoring component 218 in FIG. 2, or the monitoring component 308 in FIG. 3. The computing device may be implemented as a computing device such as, but not limited to, the computing device 102 in FIG. 1. Further, execution of the operations illustrated in FIG. 8 is not limited to a monitoring component. One or more computer-readable storage media storing computer-readable instructions may execute to cause at least one processor to implement the operations illustrated in FIG. 8.

Captured image data associated with an interior portion of an open container is processed at operation 802. A determination is made as to whether one or more sensor(s) associated with an exterior portion of the open container is available at operation 804. If yes, sensor data obtained from the exterior sensor(s) associated with the exterior portion of the open container is processed at operation 806. If no, the process proceeds to operation 808. The processed data is transmitted to an analysis engine for analysis at operation 808. The process terminates thereafter.

While the operations illustrated in FIG. 8 are performed by a computing device or server, aspects of the disclosure contemplate performance of the operations by other entities. For example, a cloud service may perform one or more of the operations.

FIG. 9 is an exemplary flowchart illustrating operation of a computing device for monitoring one or more items in an open container. The process shown in FIG. 9 may be performed by a monitoring component executing on a computing device, such as, but not limited to, the monitoring component 114 in FIG. 1 or the monitoring component 218 in FIG. 2. The computing device may be implemented as a computing device such as, but not limited to, the computing device 106 in FIG. 1. Further, execution of the operations illustrated in FIG. 9 is not limited to a monitoring component. One or more computer-readable storage media storing computer-readable instructions may execute to cause at least one processor to implement the operations illustrated in FIG. 9.

A determination is made as to whether image data is received from one or more sensors at 902. If no, image data is requested at 904 by a monitoring component, such as monitoring component 118 in FIG. 1 for example. The image data is processed at 906 by the monitoring component, an analysis engine, and/or a machine learning component.

One or more factors are identified based on the processed image data at 908. A determination is made as to whether one or more of the factors exceeds a threshold at 910. If no, the process returns to operation 902.

Returning to operation 910, if one or more of the factors exceeds a threshold, an alert is generated at 912. The alert is output to a user interface at 914. The process terminates thereafter.

The monitoring component performs operations shown in FIG. 9 independently. For example, the monitoring component may include an analysis engine and/or a machine learning component for analysis of the sensor data, such as monitoring component 218 in FIG. 2. In other examples, the monitoring component sends and receives data from one or more analysis engines and/or machine analysis components working in conjunction to analyze the sensor data, as shown in FIG. 3.

In the example shown in FIG. 9, image data received from an infrared camera is processed to identify the factor(s). In other examples, other types of sensor data are processed to identify the factor(s), such as images from a camera, temperature sensor, thermometer, or other sensor.

While the operations illustrated in FIG. 9 are performed by a computing device or server, aspects of the disclosure contemplate performance of the operations by other entities. For example, a cloud service may perform one or more of the operations.

### Additional Examples

At least a portion of the functionality of the various elements in FIG. 1, FIG. 2, FIG. 3, FIG. 4, FIG. 5, and FIG. 6 may be performed by other elements in FIG. 1, FIG. 2, FIG. 3, FIG. 4, FIG. 5, and FIG. 6, or an entity (e.g., processor, web service, server, application program, computing device, etc.) not shown in FIG. 1, FIG. 2, FIG. 3, FIG. 4, FIG. 5, and FIG. 6.

In some examples, the operations illustrated in FIG. 7, FIG. 8, and FIG. 9 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

Alternatively, or in addition to the other examples described herein, examples include any combination of the following:
monitor an exterior environment relative to the open container, the one or more sensors communicatively coupled to the communication component to transmit sensor data to the monitoring component;
wherein the one or more sensors include at least one of a thermometer, an infrared sensor, a camera, a barometer, a hygrometer, or a change-of-state sensor;
monitor an interior environment of the open container, the one or more sensors communicatively coupled to the communication component to transmit sensor data to the monitoring component;
wherein the one or more sensors include at least one of a thermometer, an infrared sensor, a camera, a barometer, a hygrometer, or a change-of-state sensor
a memory area including at least one of a temperature database, a time database, a food safety database, a time and temperature database, an item placement database, or an alert database;
wherein the image capturing device is an infrared camera;
process data received from the image capturing device and identify one or more factors corresponding to at least one of a state of the open container or one or more items contained within the open container;
wherein the one or more items are edible;
wherein the one or more factors include at least one of a food freshness level, a food spoilage indication, a food temperature indication, an item placement indication, a product package integrity indication, a component malfunction indication, or an access point state;
a machine learning component that identifies optimal item placement within the open container using the processed data from the analysis engine to generate item placement instructions;
obtaining sensor data from one or more sensors associated with the open container;
processing the obtained sensor data with the obtained captured image data to identify the one or more factors;
wherein the one or more factors comprise at least one of an item freshness level, an item spoilage indication, an item temperature indication, an item placement indication, a component malfunction indication, or an access point state;
wherein the alert comprises at least one of an alert to replace items, an alert to remove items, an alert to add items, an alert to relocate items, or an alert associated with a detected state of the open container;
wherein the obtained captured image data comprises infrared images;
obtaining sensor data from one or more sensors associated with the open container;
processing the obtained sensor data with the obtained captured image data to identify the one or more factors;
wherein the one or more factors comprise at least one of an item freshness level, an item spoilage indication, an item temperature indication, an item placement indication, a component malfunction indication, or an access point state;
wherein the alert comprises at least one of an alert to replace items, an alert to remove items, an alert to add items, an alert to relocate items, or an alert associated with a detected state of the open container; and
wherein the obtained captured image data comprises infrared images.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for monitoring an open container. For example, the elements illustrated in FIG. 1, FIG. 2, FIG. 3, FIG. 4, FIG. 5, and FIG. 6 such as when encoded to perform the operations illustrated in FIG. 7, FIG. 8, and FIG. 9, constitute exemplary means for capturing images of an interior portion of the open container; and exemplary means for transmitting the captured images of the interior portion of the open container to the monitoring component.

In other examples, the elements illustrated in FIG. 1, FIG. 2, FIG. 3, FIG. 4, FIG. 5, and FIG. 6 such as when encoded to perform the operations illustrated in FIG. 7, FIG. 8, and FIG. 9, constitute exemplary means for obtaining captured image data of an interior environment of an open container from an image capture device associated with the open container; exemplary means for processing the obtained captured image data to identify one or more factors associated with one or more items contained within the open container; and exemplary means for generating an alert responsive to at least one of the one or more identified factors exceeding a threshold.

In still other examples, the elements illustrated in FIG. 1, FIG. 2, FIG. 3, FIG. 4, FIG. 5, and FIG. 6 such as when encoded to perform the operations illustrated in FIG. 7, FIG. 8, and FIG. 9, constitute exemplary means for obtaining captured image data of an interior environment of an open container from an image capture device associated with the open container; exemplary means for processing the obtained captured image data to identify one or more factors associated with one or more items contained within the open container; and exemplary means for generating an alert responsive to at least one of the one or more identified factors exceeding a threshold.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A monitoring system for an open container, the monitoring system comprising:
a monitoring component implemented on at least one processor;
an image capturing device configured to capture images of an interior portion of the open container; and
a communication component communicatively coupled to the image capturing device and configured to transmit the captured images of the interior portion of the open container to the monitoring component.

2. The monitoring system of claim 1, further comprising:
one or more sensors associated with the open container and configured to monitor an exterior environment relative to the open container, the one or more sensors communicatively coupled to the communication component to transmit sensor data to the monitoring component.

3. The monitoring system of claim 2, wherein the one or more sensors include at least one of a thermometer, an infrared sensor, a camera, a barometer, a hygrometer, or a change-of-state sensor.

4. The monitoring system of claim 1, further comprising:
one or more sensors associated with the open container and configured to monitor an interior environment of the open container, the one or more sensors communicatively coupled to the communication component to transmit sensor data to the monitoring component.

5. The monitoring system of claim 4, wherein the one or more sensors include at least one of a thermometer, an infrared sensor, a camera, a barometer, a hygrometer, or a change-of-state sensor.

6. The monitoring system of claim 1, further comprising:
a memory area, the memory area including at least one of a temperature database, a time database, a food safety database, a time and temperature database, an item placement database, or an alert database.

7. The monitoring system of claim 1, wherein the image capturing device is an infrared camera.

8. The monitoring system of claim 1, wherein the monitoring component further comprises:
an analysis engine configured to process data received from the image capturing device and identify one or more factors corresponding to at least one of a state of the open container or one or more items contained within the open container.

9. The monitoring system of claim 8, wherein the one or more items are edible and wherein the one or more factors include at least one of a food freshness level, a food spoilage indication, a food temperature indication, product packaging integrity indication, an item placement indication, a component malfunction indication, or an access point state.

10. The monitoring system of claim 8, further comprising:
a machine learning component that identifies optimal item placement within the open container using the processed data from the analysis engine to generate item placement instructions.

11. A method for monitoring an open container, the method comprising:
obtaining captured image data of an interior environment of an open container from an image capture device associated with the open container;
processing the obtained captured image data to identify one or more factors associated with one or more items contained within the open container; and
generating an alert responsive to at least one of the one or more identified factors exceeding a threshold.

12. The method of claim 11, further comprising:
obtaining sensor data from one or more sensors associated with the open container; and
processing the obtained sensor data with the obtained captured image data to identify the one or more factors.

13. The method of claim 11, wherein the one or more factors comprise at least one of an item freshness level, an item spoilage indication, an item temperature indication, an item placement indication, a component malfunction indication, or an access point state.

14. The method of claim 11, wherein the alert comprises at least one of an alert to replace items, an alert to remove items, an alert to add items, an alert to relocate items, or an alert associated with a detected state of the open container.

15. The method of claim 11, wherein the obtained captured image data comprises infrared images.

16. One or more computer storage devices having computer-executable instructions stored thereon for monitoring an open container environment, which, on execution by a computer, cause the computer to perform operations comprising:
obtaining captured image data of an interior environment of an open container from an image capture device associated with the open container;
processing the obtained captured image data to identify one or more factors associated with one or more items contained within the open container; and
generating an alert responsive to at least one of the one or more identified factors exceeding a threshold.

17. The one or more computer storage devices of claim 16 having further computer-executable instructions comprising:
obtaining sensor data from one or more sensors associated with the open container; and
processing the obtained sensor data with the obtained captured image data to identify the one or more factors.

18. The one or more computer storage devices of claim 16, wherein the one or more factors comprise at least one of an item freshness level, an item spoilage indication, an item temperature indication, an item placement indication, a component malfunction indication, or an access point state.

19. The one or more computer storage devices of claim 16, wherein the alert comprises at least one of an alert to replace items, an alert to remove items, an alert to add items, an alert to relocate items, or an alert associated with a detected state of the open container.

20. The one or more computer storage devices of claim 16, wherein the obtained captured image data comprises infrared images.
